(19) United States
(12) Patent Application Publication
(10) Pub. No.: US 2024/0014483 A1
(43) Pub. Date: Jan. 11, 2024

(54) TERMINAL ASSEMBLIES AND METHODS OF USING AND MAKING THE SAME

(71) Applicant: EAGLEPICHER TECHNOLOGIES, LLC, Joplin, MO (US)

(72) Inventors: Frank Joseph PUGLIA, Joplin, MO (US); Jeffrey C. HALL, Joplin, MO (US); Svetlana TREBUKHOVA, Joplin, MO (US); Stuart SANTEE, Joplin, MO (US); Michael CAVANAGH, Joplin, MO (US); Christine COOK, Joplin, MO (US); Joe WALLACE, Joplin, MO (US)

(21) Appl. No.: 18/035,019

(22) PCT Filed: Nov. 1, 2021
(86) PCT No.: PCT/US2021/057567

§ 371 Date: May 2, 2023

Related U.S. Application Data
(60) Provisional application No. 63/109,202, filed on Nov. 3, 2020.

(51) Int. Cl. H01M 50/178; H01M 50/553; H01M 50/567

(52) U.S. Cl. CPC H01M 50/178; H01M 50/553; H01M 50/567; H01M 50/55

(57) ABSTRACT

A cell terminal assembly including: an outer terminal configured to be disposed at an external location of a cell, the outer terminal including a feedthrough passage, the feedthrough passage including a recess having a seating surface; and an inner terminal including an electrically inner terminal including a feedthrough member electrically connecting the conductive body to the outer terminal, the feedthrough member including a head portion having a shape that conforms to a shape of the recess and the seating portion and secures the feedthrough member thereto.

### CROSS REFERENCE TO RELATED APPLICATIONS

This application claims priority to and the benefit of U.S. Provisional Application No. 63/109,202, filed Nov. 3, 2020, which is incorporated herein by reference in its entirety.

### BACKGROUND

The disclosed subject matter relates to batteries, and methods of use and manufacture thereof. More particularly, the disclosed subject matter relates to terminal assemblies.

Battery technology is used in a wide variety of industries and applications, such as automotive, military, and renewable energy industries. Safe and efficient electrical connections between batteries and devices to be powered is an important aspect of battery technologies. In high power applications, it can be challenging to design terminals that are capable of high power transmission and are suitably compact. In particular, for aerospace applications, there remains a need for terminals that provide high power capability and have properties suitable for aerospace application.

### SUMMARY

An embodiment of a cell terminal assembly includes an outer terminal configured to be disposed at an external location of a cell, the outer terminal including a feedthrough passage, the feedthrough passage including a recess having a seating surface. The assembly also includes an inner terminal including an electrically conductive body configured to be disposed within a housing of the cell, the inner terminal including a feedthrough member electrically connecting the conductive body to the outer terminal, the feedthrough member including a head portion having a shape that conforms to a shape of the recess and the seating portion and secures the feedthrough member thereto.

An embodiment of a cell terminal assembly includes an outer terminal configured to be disposed at an external location of a cell, the outer terminal including a feedthrough passage, the feedthrough passage including a recess having a seating surface, and an inner terminal including an electrically conductive body configured to be disposed within a housing of the cell. The inner terminal includes a feedthrough member configured to electrically connect the conductive body to the outer terminal, and the feedthrough member includes a head portion configured to be shaped to conform to a shape of the seating portion and secure the feedthrough member thereto.

An embodiment of a method of manufacturing a cell terminal assembly includes providing an inner terminal including an electrically conductive body configured to be disposed within a housing of the cell, the inner terminal including a feedthrough member, and electrically connecting the inner terminal to an outer terminal configured to be disposed at an external location of a cell, the outer terminal including a feedthrough passage that includes a recess having a seating surface. The connecting includes inserting the feedthrough member into the feedthrough passage, and deforming a head portion of the feedthrough member to conform the head portion to a shape of the recess, the deformed head portion providing an electrical connection between the inner terminal and the outer terminal and providing a fluid tight seal between the head portion and the seating surface.

Various further aspects, embodiments, and features of the disclosure are described herein.

### BRIEF DESCRIPTION OF THE DRAWINGS

The disclosed subject matter will now be described in more detail with reference to exemplary embodiments of apparatuses and methods, given by way of example, and with reference to the accompanying drawings, in which:

FIG. 1 depicts an example of a cell;

FIG. 2 is a cross-section view of an embodiment of a terminal assembly;

FIG. 3 is an exploded, cross-section view of the terminal assembly of FIG. 2;

FIG. 4 depicts an embodiment of a terminal assembly including an inner terminal connected to an outer terminal or insert via a feedthrough member having a portion that is shaped to conform to a passage and/or recess in the outer terminal;

FIGS. 5A-5D (collectively referred to as “FIG. 5”) depict an example of a pouch-type cell;

FIG. 6 is an exploded view of an embodiment of a terminal system including a negative terminal assembly and a positive terminal assembly;

FIG. 7 is an exploded view of an embodiment of a terminal system including a negative terminal assembly and a positive terminal assembly;

FIG. 8 depicts an embodiment of a terminal system including terminal assemblies and an overmolded insulator;

FIG. 9 is a side cross-sectional view of an embodiment of the terminal assembly of FIG. 8;

FIG. 10 is a side cross-sectional view of an embodiment of the terminal assembly of FIG. 8;

FIG. 11 is a side cross-sectional view of the terminal assembly of FIG. 10 after compression;

FIG. 12A is a side cross-sectional view of an embodiment of the terminal assembly of FIG. 8;

FIG. 12B is a side cross-sectional view of an embodiment of the terminal assembly of FIG. 8 after compression;

FIG. 13 depicts an example of a cover portion of a cell housing;

FIG. 14 depicts the cover portion of FIG. 13 with an overmolded insulator;

FIG. 15 depicts the cover portion of FIG. 13 with two separate overmolded insulators;

FIGS. 16A-16C (collectively referred to as “FIG. 16”) depict components of a terminal assembly and stages of an embodiment of a method of manufacture;

FIGS. 17A-17C (collectively referred to as “FIG. 17”) depict components of a terminal assembly and stages of the method of manufacture illustrated by FIG. 16;

FIG. 18 is a perspective view of an embodiment of a terminal system including terminal assemblies manufactured according to the method of FIGS. 16 and 17;

FIG. 19 is a perspective view of components of a terminal assembly;

FIG. 20 depicts an example of a battery assembly that includes an embodiment of a cooling feature or cooling system.

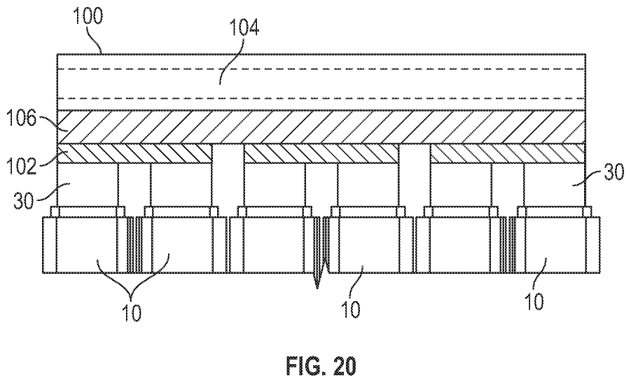

### DETAILED DESCRIPTION

Aspects of the disclosed embodiments are explained in detail below with reference to the various drawing figures. Exemplary embodiments are described to illustrate the disclosed subject matter, not to limit its scope, which is defined by the claims. Those of ordinary skill in the art will recognize a number of equivalent variations of the various features provided in the description that follows.

Embodiments described herein relate to energy storage devices, terminal assemblies for electrically connecting energy storage devices, methods of providing electrical power and methods of manufacture. The energy storage device may be an electrochemical cell, i.e., a cell, such as a lithium ion (Li-ion) cell. A battery comprises a plurality of cells connected in any suitable combination of series and parallel connections. Although a battery comprises a plurality of cells, for convenience and as the term “battery” is used in commerce, a cell may be referred to as a battery.

An embodiment of a terminal assembly includes at least one inner terminal electrically connected to internal components of the cell (e.g., a Li-ion cell), at least one outer terminal, and one or more conductive members configured to electrically connect the inner terminal(s) and the outer terminal(s).

The conductive members are referred to herein as “feedthrough members,” which may include a positive feedthrough member and a negative feedthrough member for the positive and negative terminals of the cell, respectively. The feedthrough members may comprise any suitable conductive material. For the positive feedthrough member, representative materials include aluminum, molybdenum, titanium, stainless steel, gold, an alloy thereof, or a combination thereof. For the negative feedthrough member, representative materials include copper, titanium, aluminum, molybdenum, nickel, stainless steel, gold, an alloy thereof, or a combination thereof. The feedthrough members may be configured as rigid cylindrical members or bars, or have any suitable size or shape.

In an embodiment, each feedthrough member is shaped to provide a secure electrical connection between the inner and outer terminals, and to seal an internal volume of the cell. In an aspect, the feedthrough member is shaped by deformation. For example, during manufacture, a feedthrough member is inserted into a feedthrough passage in the outer terminal, and a portion of the feedthrough member is deformed to conform the portion of the feedthrough member to an upper portion of the feedthrough passage. Deformation of the feedthrough member creates mechanical compression for both sealing and ensuring an electrical connection between components of the battery. The feedthrough members may be rivets or any other suitable conductive body, and may be formed so that they are integral with an inner terminal, outer terminal, or attached to an inner terminal as a separate part via an adhesive or mechanical attachment (e.g., a weld or solder). The size, shape and number of feedthrough members can be determined based the electrical current demands of powered device without undue experimentation.

In an aspect, each feedthrough member is configured as or includes a rivet that can be punched or otherwise deformed to form a head portion that conforms to the shape of a recess or cavity in an outer terminal. The head portion may be both radially deformed to seal against radial (side) surfaces of the recess, and axially deformed to seal against a seating face of the recess. The head portion can thus be deformed to fill a volume in the recess without any gaps, and thereby secure the inner terminal to the outer terminal and seal the recess. The deformed head portion may include an axially facing head surface that can be connected to an external device or component for providing power thereto.

Embodiments described herein present a number of advantages and technical effects. The terminal assemblies described herein are capable of handling very high electrical current while also allowing for traditional, mechanical, intercell connections or welded intercell connections. Electrical connection from the inside to the outside of the cell can be made through the deformation of a rivet (feedthrough pin) in such a way that the feedthrough makes or affects effective contact with an outside part, mechanism, or structure. In addition, deformation of the feedthrough pins also acts to minimize or reduce the height and maximize the diameter to provide an effective seal. The relatively large diameter and short length of the feedthrough pins also provides an improved form factor as compared to glass-to-metal seals.

The deformation process provides a high degree of contact between the feedthrough pin and an outer terminal, which results in a feedthrough with a resistance that is less than that of commercially available terminals. The resistance of the disclosed feedthrough may be 0.1 microohms (μΩ) to 1 Ω, 1 μΩ to 100 μΩ, or 5 μΩ to 50 μΩ. The reduced resistance reduces the need for cooling and allows for integral cell cooling features and functionality through the terminal assembly due to reduced resistive heating of the cell, resulting in an improved thermal design that is a result of reducing electrical resistance.

The feedthrough pins described herein are also capable of supporting high electrical current (e.g., 2000 amperes), while maintaining a compact design. Current densities over 20 kA/in² have been demonstrated for continuous operation, and over 200 kA/in² in pulse operation without adverse effects, such as deformation or leakage. In an aspect, the disclosed feedthrough provides 1 kiloampere per square inch (kA/in²) to 500 kA/in², 5 kA/in² to 100 kA/in², or 10 kA/in² to 50 kA/in² without adverse effects, such as deformation.

Furthermore, the terminals described herein provides for improved leak rates and extended temperature operating range as compared to prior art terminal systems. For example, at least some embodiments are capable of providing a leak rate of less than 10⁻⁶ ccHe/s (cubic centimeters of Helium per second), 10⁻⁶ to 10⁻¹⁰ ccHe/s, 5·10⁻⁷ to 5·10⁻⁹, or 5·10⁻⁷ to 5·10⁻⁸ ccHe/s, while also providing suitable electrical current carrying rate capability. At least some embodiments are capable of operating and maintaining a seal having the above leak rate at a temperature of, for example, −60 degrees Celsius (° C.), −50° C., −40° C., to 65° C., 75° C., or 85° C. Providing a leak rate of less than 10⁻⁶ ccHe/s, e.g., less than 10⁻⁷ ccHe/s, or less than 10⁻⁸ ccHe/s over the temperature range of −60° C. to 85° C. is mentioned. In comparison, prior art terminals develop a leak or become inoperable after excursion to a temperatures above 60° C., or when thermally cycled between −60° C. and 85° C.

The sealing capability and low leak rates of the terminals described herein permit the terminals to be used in batteries for aerospace applications (e.g., aviation and/or space exploration). For example, the terminals have leak rates that satisfy the National Aeronautics and Space Administration (NASA) Technical Standard NASA-STD-7012, Approved on Mar. 3, 2005, the content of which is incorporated herein in its entirety.

He leak rates can be determined according to ASTM D4991-07, the content of which is incorporated herein by reference in its entirety. Alternatively, the He leak rate can be determined as disclosed in Wetzig, D. and Reismann, M., “Methods for Leak Testing Lithium-Ion Batteries to Assure Quality with Proposed Rejection Limit Standards,” SAE Technical Paper 2020-01-0448, 2020, https://doi.org/10.4271/2020-01-0448, the content of which is incorporated herein in its entirety.

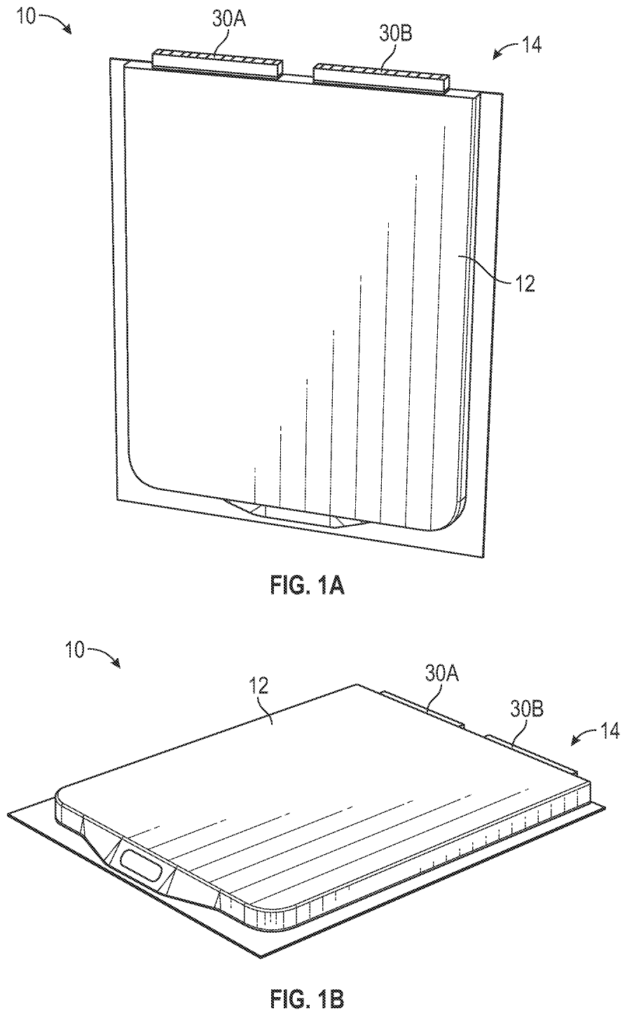

FIG. 1 depicts an example of a cell 10, which may be an electrochemical cell such as a lithium-ion cell. The electrochemical cell may be any suitable device or assembly for storing and/or generating electricity. For example, the electrochemical cell may be a primary cell, a secondary cell, or a capacitor such as a lithium-ion capacitor or an ultracapacitor.

The cell 10 includes a body or case 12 (also referred to as a can) that houses internal battery components, and a terminal system 14. Although not shown, the cell 10 may be part of an insulated cell assembly that is assembled with other cells to provide a battery. The cell 10 and/or the battery may be used to provide power to any suitable system or device, such as an aircraft system. The terminal system 14 includes positive and negative terminal assemblies configured as a positive terminal 30A and a negative terminal 30B. It is noted that the terminal system 14 may have two terminals as shown, or a single terminal (e.g., only the positive terminal 30A if the case 12 serves as the negative terminal).

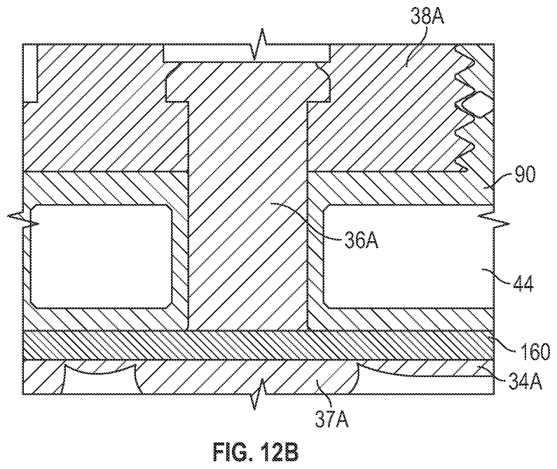

Cell cooling can be enhanced by providing a thermally conductive member on the cell terminal or intercell connector. The thermally conductive member may comprise any suitable material having suitable thermal conductivity and having suitable electrical insulating properties. Representative materials include aluminum nitride, boron nitride, or a combination thereof. Additionally, an electrically insulating gap pad may be utilized to allow for the use of a materials that is electrically conductive (e.g., copper, or aluminum). On the thermally conductive member, a cooling plate may be provided. Aluminum nitride and boron nitride are representative materials that have suitable thermal conductivity and are suitable electrical insulators for the thermally conductive member. Examples of cooling features are shown and discussed in conjunction with FIG. 14.

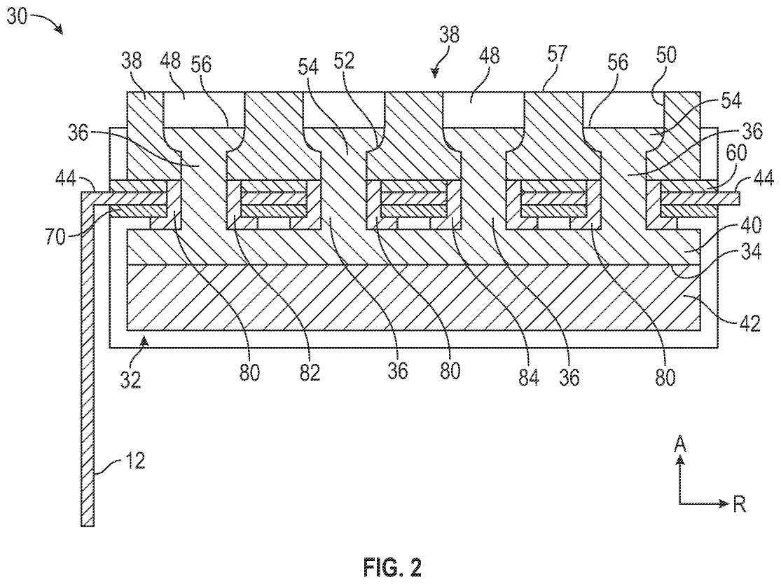

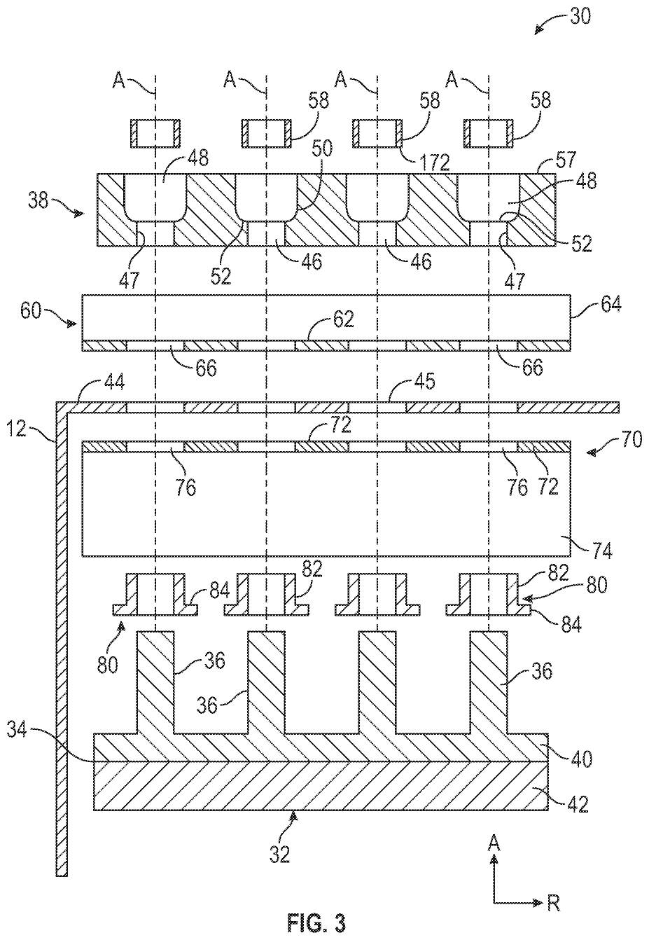

FIGS. 2 and 3 depict an embodiment of a terminal assembly 30, which can be incorporated into the cell 10. FIG. 2 shows the terminal assembly 30 after components are assembled and the feedthrough pins 36 are deformed or otherwise shaped to connect the inner and outer terminals. FIG. 3 is an exploded view of the terminal assembly 30 prior to shaping and/or deformation of the feedthrough pins 36.

The terminal assembly 30 includes an optional inner terminal 32 having a terminal body 34 and a plurality of deformable feedthrough members, referred to as feedthrough pins 36. The feedthrough pins 36 extend axially from an interior of a cell housing (e.g., the case 12) to an exterior thereof to connect the inner terminal 32 to an outer terminal 38. As discussed further below, the feedthrough pins 36 are deformable and/or are shaped to provide a sealed connection and an electrical connection between the inner terminal 32 and the outer terminal 38.

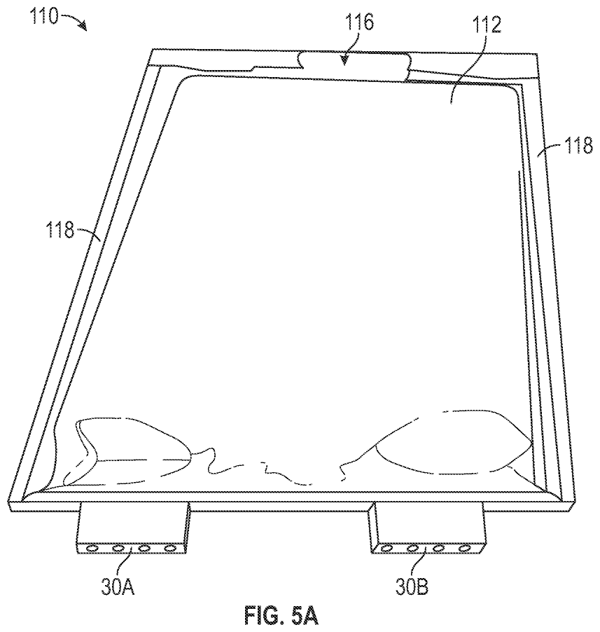

In an aspect, the inner terminal body 34 may be a solid copper body (e.g., for a negative terminal assembly) or a solid aluminum body (e.g., for a positive terminal assembly) that forms a post plate 40 to support the feedthrough pins 36, and a flat vertical plate or flag 42 that acts as a current collector. For example, as shown in FIG. 5, the flag 42 extends axially and parallel to the longitudinal axis of the feedthrough member 36. In an aspect, the flag 42 is radially offset (e.g., offset in a direction perpendicular to the longitudinal axis) relative to the feedthrough member 36.

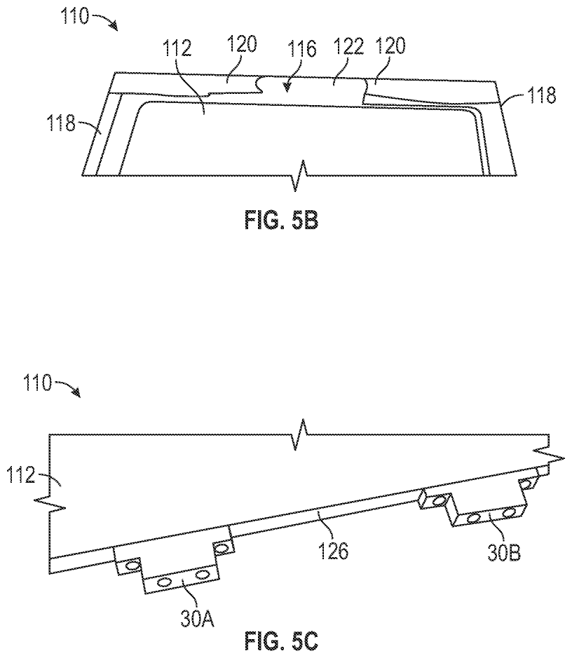

In an embodiment, the terminal flag 42 is offset from being symmetrical to the centerline of a cover (e.g., a cover 44 as discussed below) so that one side of the terminal flag 42 is on the centerline of the cover. The centerline, for example, extends in a direction perpendicular to the axis A and the axis R, and is illustrated in FIG. 6.

The offset direction can the same or opposite for the positive and negative electrodes. The purpose of the offset is so that when electrode tabs are gathered for weld attachment to the terminal flag 42, a symmetrical arrangement of the electrode tabs is achieved. In other words, by having the connection point offset, the tabs are gathered to the center, along the centerline. Having the tabs gathered along the centerline provides for improved uniformity of the tab length and their electrical resistance, e.g., the tabs of the outer electrodes are the same length, gradually decreasing in length to the center of a cell stack. The offset configuration of the flag 42 also creates a location for the feedthrough pins 36 or other feedthrough members to make electrical connection to the flag 42 without interference. In the case where tabs are welded to both sides of the flag 42, the flag 42 should remain along the cell centerline.

The inner terminal body 34 is not so limited and can have any suitable size and shape. In an aspect, the feedthrough pins 36 are integrally formed with the inner terminal body 34. However, the feedthrough pins 36 can be separate components that are welded, soldered or otherwise attached to the internal terminal body 34.

It is noted that, although the feedthrough pins 36 are part of the inner terminal 32, the feedthrough pins 36 may be part of the outer terminal 38. For example, the feedthrough pins 36 may be integral with or attached to the outer terminal 38, and may be inserted into passages in the inner terminal 32 and deformed or shaped to conform portions of the feedthrough pins 36 to a passage, recess or cavity in the inner terminal 32.

The inner terminal 32 and the outer terminal 38, or components thereof, are made from a conductive material such as aluminum or copper, or any other electrochemically stable metal, alloy, or other suitable material. In an aspect, the inner terminal body 34 and the outer terminal 38 comprise a solid metallic material. The outer terminal 38 and/or other external components may or may not be electroplated.

When assembled, each feedthrough pin 36 extends through a cover 44 of the case 12 (or other housing) into a feedthrough passage 46 in the outer terminal 38. The feedthrough passage 46 includes a cylindrical lower portion 47 and upper portion 48 that is shaped and sized to secure a feedthrough pin 36. The upper portion 48 may be formed as a counterbore or other recess that forms a seat having radial and axially facing portions. An “axial” direction is a direction parallel to a longitudinal axis of a feedthrough pin 36, and a “radial” direction is a direction perpendicular to the axial direction.

For example, as shown in FIG. 3, the recess defined by the upper portion 48 forms a radially facing side surface 50. The side surface 50 may be parallel to a longitudinal axis of the feedthrough pins 36 (shown as an axis A), or have a different configuration (e.g., curved and/or angled relative to the longitudinal axis). The upper portion 48 also forms an axially facing seating surface 52 that may be parallel to a radial axis R that is orthogonal to the longitudinal axis A, or have any other suitable configuration, such as a curved or angled configuration. For example, the side surface 50 and the seating surface 52 can be configured to have an overall dovetail or square design.

The feedthrough pin 36 is secured within the feedthrough passage 46 by deforming a head portion 54 of the feedthrough pin 36 to conform the head portion 54 to the shape of the recess 48. As a result, the head portion 54 is in contact with both the seating surface 52 and the side surface 50. This configuration provides a high surface area electrical connection between the inner and outer terminals, and a fluid tight seal. A fluid tight seal is provided, in an embodiment, by radial and axial compression of an internal insulator 70, an external insulator 60 and bushings 80.

In an embodiment, the deformed head portion 54 has a flat axially facing surface 56 that can be connected to an external device. It is noted that the head portion 54 can have any desired shape or profile. For example, the head portion can be curved, convex, concave or flat, or can have integral features such as internal threads or a shape corresponding to an external connection.

The feedthrough pins can be of varying height relative to the outer terminal 38. For example, the facing surface 56 can be positioned below an outer surface 57 of the outer terminal 38 as shown in FIG. 2, can be level or flush with the outer surface 57, or extend beyond the outer surface 57. Additionally, the facing surfaces 56 of each feedthrough pin 36 can all be of the same or similar height, or can be of varying height.

The outer terminal 38 may include connection mechanisms or features to facilitate connecting the feedthrough pin 36 to a device to be powered. For example, as shown in FIG. 3, an optional connection insert 58 can be inserted into each recess 48. The connection inserts 58 may be inserted into the recess 48 prior to deformation or after deformation. For example, the connection insert 58 can be inserted into the recess after deformation and secured via, e.g., welding or adhesive. The connection insert 58 may include internal threads or other features to facilitate connection of the outer terminal to an external device.

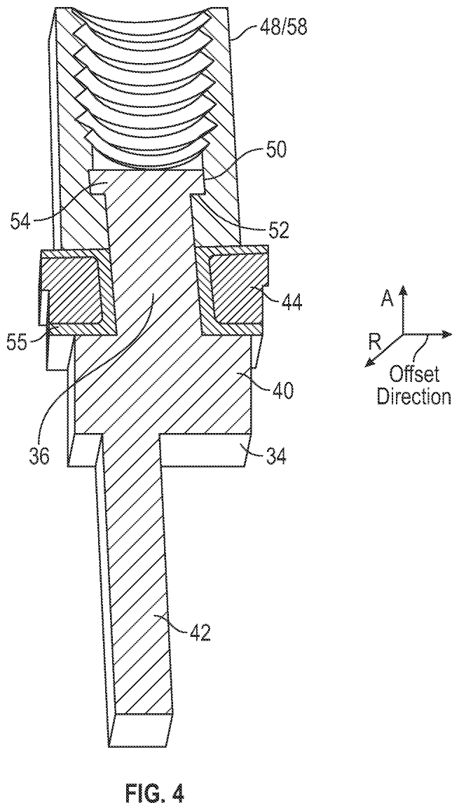

Alternatively, referring to FIG. 4, the head portion 54 is deformed after the insert 58 is in place, or deformed directly onto the recess 48 (e.g., if the recess 48 has internal threads). FIG. 5 depicts an embodiment of the terminal assembly 30, in which the head portion 54 has been deformed so as to contact the side surface 50 and the seating surface 52 of the recess 48, or on the surfaces of an insert 58. A sealing material 55 (e.g., ethylene-tetrafluoroethylene (ETFE) resin, such as TEFZEL, or polysulfone) may be included between the feedthrough pin 36 and the cover 44.

The terminal assembly 30 may include additional components to facilitate power transmission and battery operation. For example, the terminal assembly 30 may have an integral voltage tap or thermocouple tap. The voltage tap may include an additional screw, landing area for a spring connection, or other suitable connection that is not directly part of power transmission path of the cell 10. An example of a voltage tap 59 is shown in FIG. 5.

In an embodiment, the terminal assembly 30 includes one or more insulating components that electrically insulate the inner and outer terminals. For example, as shown in FIGS. 2 and 3, the terminal assembly 30 includes an external insulator 60 disposed between the cover 44 and the outer terminal 38. In an aspect, the external insulator 60 includes a portion 62 having surfaces that are orthogonal to the axis A, and side portions 64 having surfaces that are parallel to the axis A. The portion 62 includes through holes 66 that align with the feedthrough passages 46, and with holes 45 in the cover 44, when the terminal assembly 30 is assembled. The external insulator 60 thus engages with the bottom and sides of the outer terminal 38 to provide electrical insulation along the bottom and sides of the outer terminal 38.

The terminal assembly 30, as shown in FIGS. 2 and 3, may also include an internal insulator 70 disposed between the cover portion 44 and the inner terminal 32. In an aspect, the internal insulator 70 includes a portion 72 having surfaces that are orthogonal to the axis A and holes 76 aligned with the feedthrough pins 36. The internal insulator 70 also includes side portions 74 having surfaces that are parallel to the axis A. The portion 72 and the side portions 74 provide insulation for the inner terminal body 34. The internal insulator may be made from any suitable insulating material, such as ethylene-tetrafluoroethylene (ETFE), such as TEFZEL or other suitable polymer (e.g., polysulfone).

The terminal assembly 30 may include additional insulating components, such as sleeves, bushings and/or injected insulating material. For example, the terminal assembly of FIGS. 2 and 3 includes electrically insulating bushings 80 that are each fitted over a feedthrough pin 36. The bushings 80 may be made from any suitable insulating material, such as ethylene tetrafluoroethylene (ETFE) and/or other polymer, such as polysulfone. Each insulating bushing 80 includes a radially facing sleeve portion 82 and an axially facing flange portion 84. The sleeve portion 82 is cylindrical and provides a seal and insulates the feedthrough pin 36 and the assembled cover portion and insulators. The flange portion 84 is disposed between the internal insulator 70 and the terminal body 34. In addition to providing a seal, the bushing 80 provides a mechanism to prevent undesired movement or vibration.

FIGS. 5A-5D depict another example of a cell 110 that may incorporate an embodiment described herein. The cell 110 may be an electrochemical cell such as a lithium-ion cell. The cell 110 in this embodiment includes a positive electrode (e.g., a cathode) and a negative electrode (e.g., an anode), with a separator therebetween, arranged within a pouch 112. The cell 110 may include a single positive electrode and a single negative electrode, or a plurality of positive electrodes and a plurality of negative electrodes to provide an electrode stack. The pouch 112 may be formed of one or more sheets of material (e.g., metallized foil, e.g., an aluminum coated polymer, such as aluminum coated polyethylene, polypropylene, polypropylene terephthalate, or polypropylene terephthalate) which may be folded or wrapped about the electrodes to form the electrochemical portion of the cell 110. The cell 110 includes terminals 30A and 30B extending out an end of the pouch 112. Opposite the terminals 30A and 30B is a vent 116.

Referring to FIGS. 5B and 5C, the material of the pouch 112 may be crimped, bonded, heat sealed, or otherwise sealed around a periphery 118 thereof. At the end of the pouch 112 having the vent 116, a first side 120 of the pouch 112 may be folded over a second side of the pouch 122 and a recess 124 in the first side 120 defines and forms the vent 116 when joined or bonded together. FIG. 5D illustrates the material or sheet of the pouch 112 prior to encasing the sheets of material of the cell 110. As shown, the material or sheet of the pouch 112 includes a midsection 126 that is between the first side 120 and the second side 122 thereof. The midsection 126 includes terminal apertures 128 configured to enable electrical connection between the terminals 114 and the sheets of material contained within the pouch 112. The midsection 126 provides for a continuous material around the end of the cell 110 having the terminals 114.

The pouch 112 may comprise any suitable metallized film (e.g., an aluminum coated polyethylene film). In some configurations that use non-metallic materials, the assembled cell 110 may be sealed within a hermetic cell housing. The periphery 118 and the ends of the sides 120, 122 can be joined through folding of the material of the pouch 112 itself. Such folds can provide high strength while minimizing assembly steps, costs, and processes.

Because the cell 110 is formed by folding the two sides 120, 122 about the sheets of material, bends or creases in material may form during assembly. To avoid such creases and bends, which can be detrimental and form weak spots in the assembled cell, optional spacers may be arranged within the pouch. Such spacers may also operate as insulators, or alternatively, additional insulators may be arranged within the pouch. The insulators and/or spaces can have rounded corners, thus minimizing the chance of piercing or damaging the material of the pouch 112. The insulators or spacers may also be configured to keep metalized layer(s) from becoming polarized, which can lead to shorts or corrosion.

FIG. 6 shows an embodiment of a terminal system that incorporates the terminal assemblies 30. The terminal system (e.g., the terminal system 14) in an embodiment includes two terminal assemblies 30, where one of the terminal assemblies 30A is a positive terminal, and the other terminal assembly 30B is a negative terminal.

For example, the positive terminal assembly 30A includes an inner terminal 32A and a plurality of feedthrough pins 36A. The inner terminal 32A includes a terminal body 34A having a post plate 40A and a vertical plate or flag 42A. The positive terminal assembly 30A also includes an outer terminal 38A. The inner terminal 32A, the inner terminal body 34A and the feedthrough pins 36A are comprised of, e.g., aluminum. The outer terminal 38A is comprised of, e.g., copper or aluminum.

For example, the negative terminal assembly 30B includes an inner terminal 32B and a plurality of feedthrough pins 36B. The inner terminal 32B includes a terminal body 34B having a post plate 40B and a vertical plate or flag 42B. The negative terminal assembly 30B also includes an outer terminal 38B. The inner terminal 32B, the inner terminal body 34B, the feedthrough pins 36B and the outer terminal 38B are comprised of, e.g., copper. The terminal assemblies 30A and 30B are not so limited, and can be made from any suitable material or combination of materials.

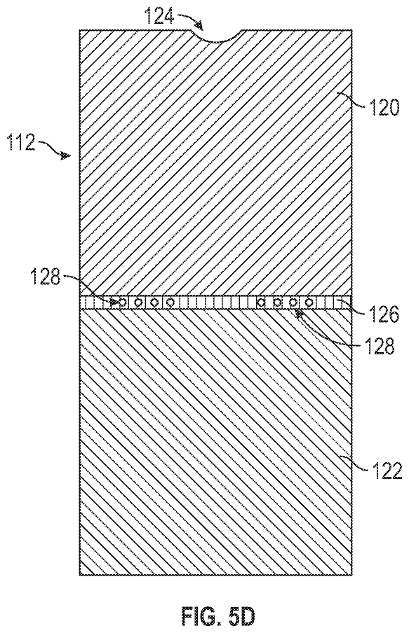

FIG. 7 depicts a terminal system that includes an embodiment of the terminal assembly 30, in which one terminal assembly 30B is a negative terminal and the other terminal assembly 30A is a positive terminal. The negative terminal assembly 30B includes an inner terminal 32B and feedthrough pins 36B made from copper, and an outer terminal 38B made from copper. The positive terminal assembly 30A includes an inner terminal 32A, feedthrough pins 36A and an outer terminal 38A made from aluminum. The terminal assemblies 30A and 30B are not so limited, and can be made from any suitable material or combination of materials.

The inner terminals 32A and 32B may each have a respective terminal body 34A and 34B that is rectilinear, e.g., rectangular. The external insulator 60 is a flat plate for insulating the terminal body 34A and the terminal body 34B. The insulating bushings 80, in this embodiment, are disposed between the outer terminal 38A and the cover 44, and disposed between the outer terminal 38B and the cover 44, and may have similar dimensions as discussed above.

In an embodiment, the terminal assembly 30 includes a single insulating body to provide insulation to the inner and outer terminals. For example, instead of multiple individual insulators, a single insulating body is provided that lines surfaces and through holes of the cover.

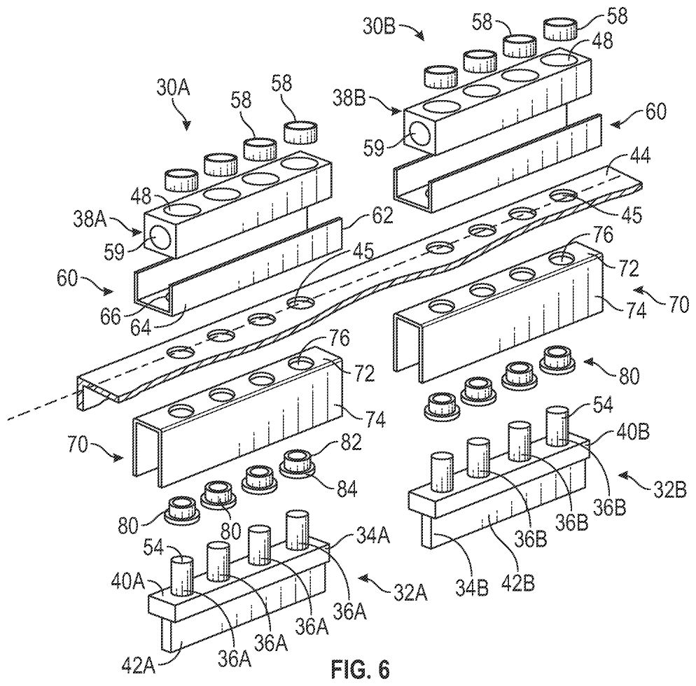

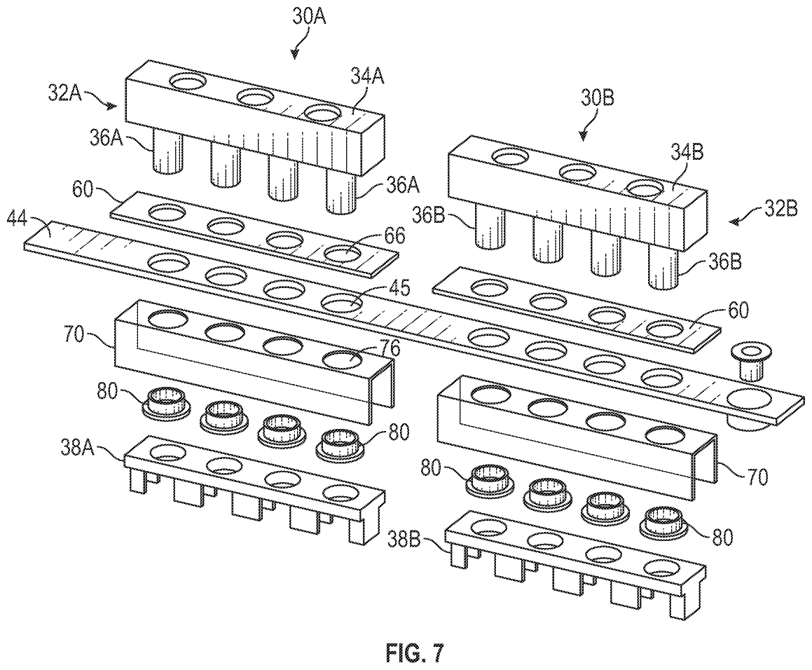

FIGS. 8-11 and FIGS. 12A-B show embodiments of a terminal system and terminal assemblies 30A and 30B that include an insulator 90 overmolded onto the cover 44. The insulator 90 may be made from any suitable insulating material, such as ethylene-tetrafluoroethylene (TEFZEL), polysulfone, or other suitable polymer. The insulator 90 electrically isolates the inner terminals 32A and 32B, the outer terminals 38A and 38B and the feedthrough pins 36A and 36B from the cover 44. The isolation resistance between the outer terminals 38A and 38B and the cover 44 is, for example, greater than 1 megaohm (Mohm), greater than 1 gigaohm (Gohm), 1 Mohm to 100 Gohms, 10 Mohm to 50 Gohms, or 35 Gohms. The isolation resistance in these examples may be measured at 500 Volts. In an embodiment, both of the outer terminals 38A and 38B are made from copper. The terminal assembly 30B includes an inner terminal body 32B and feedthrough pins 36B made from copper, and the other terminal assembly 30A includes an inner terminal body 32A and feedthrough pins 36A made from aluminum. In FIG. 9, the internal insulator 70 may be included in the overmold, may be a separate piece, may be excluded or may be included as part of an electrode stack. For example, the internal insulator 70 can be replaced with adhesive tape or an insulator on the case 12.

The feedthrough pins 36A and 36B, in an aspect, are separate bodies, such as individual rivets, which are attached to the respective inner terminal bodies 34A and 34B via deformation, welding and/or other connection mechanism. The inner terminal bodies 34A and 34B, in an aspect, each include a flat plate having a portion including through holes for the feedthrough pins 36A and 36B, respectively. The flat plate also includes a portion bent at a 90 degree angle, as shown in FIG. 9.

The outer terminals 38A and 38B may each include a plurality of feedthrough passages 46A and 46B, respectively. Each feedthrough passage includes an upper portion 48 configured as a recess in the form of a counterbore. The recess 48 is generally cylindrical and includes a seating surface 52 orthogonal to the longitudinal axis A of the feedthrough pin 36A, and a circumferential side surface 50 that defines a diameter and is generally parallel to the axis A. As shown, the feedthrough pin 36A has been deformed or otherwise shaped to create a cylindrical head portion that contacts the seating surface 52 and the side surface 50. A suitable sealant, such as a suitable polymer sealant (e.g., parylene, epoxy, a room-temperature-vulcanizing (RTV) silicone, or other RTV sealant such as an acrylic RTV), may be applied to fill the recess 48 above the facing surface 56 to avoid corrosion.

FIG. 9 shows a cross-section of the terminal assembly 30A and illustrates the recess 48. The terminal assembly 30B may include similarly configured recesses 48 through which feedthrough pins 36B are inserted and secured by deforming or otherwise shaping head portions thereof.

The diameter of each feedthrough pin 36A and/or 36B is selected to correspond with the diameter of the holes formed by the overmolded insulator 90. The diameter may be selected to define a desired tolerance (e.g., 0.001 inches or 25 μm) relative to the insulator holes and/or the feedthrough passage. Examples of feedthrough passage diameters include 0.1 to 1 millimeter (mm) (0.005″ to 0.040″), 1 mm to 10 mm (0.040″ to 0.375″), or 10 mm to 13 mm (0.375″ to 0.500″).

FIG. 9 shows an embodiment in which the feedthrough pin 36A includes a semi-circular base portion 37A. The base portion 37A may have any desired shape, such as a circular shape, wedge shape or other shape.

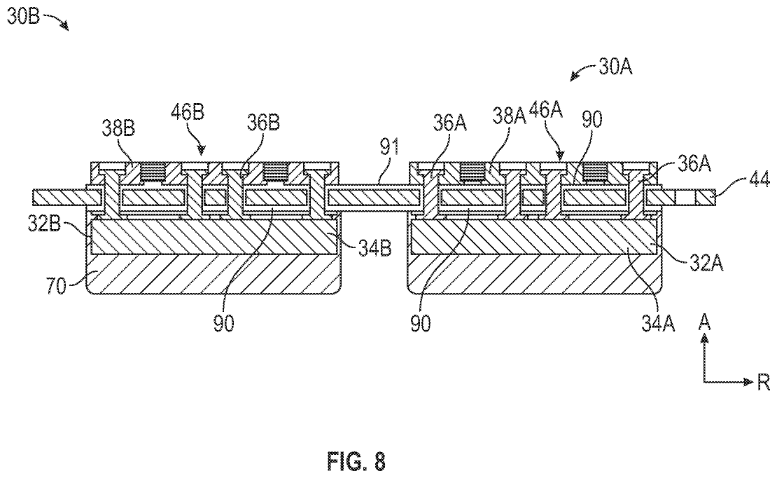

FIG. 10 shows an alternative embodiment of the terminal assembly 30A. In this embodiment, the base portion 37A is a circular base portion. To accommodate the base portion 37A, the inner terminal body 34A includes a series of openings 39A to accommodate each base portion of each feedthrough pin. The openings 39A are each configured as a window through which part of the base portion 37A extends when assembled. The opening 39A can be a circular or rectangular window, or have any other suitable size and shape.

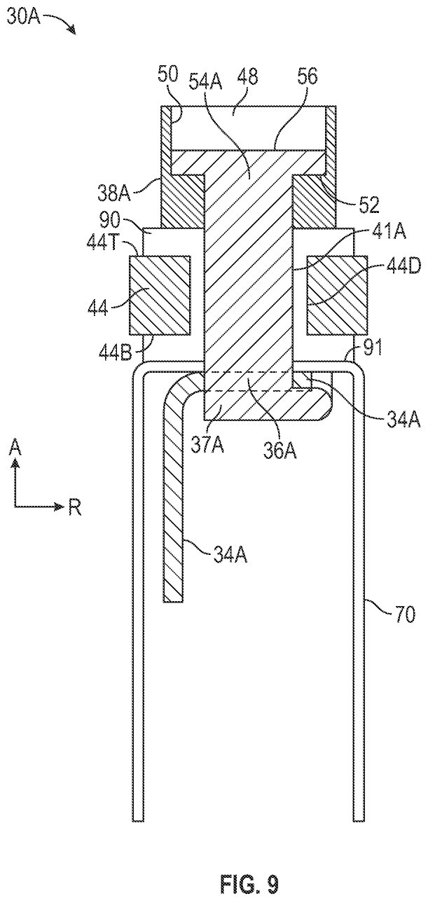

FIG. 11 shows a portion of the terminal assembly 30A after compression. As shown, a section of the inner terminal body 34A, in some instances, can deflect, which can potentially create a leak path in an interface region between the base portion 37A and the cover 44.

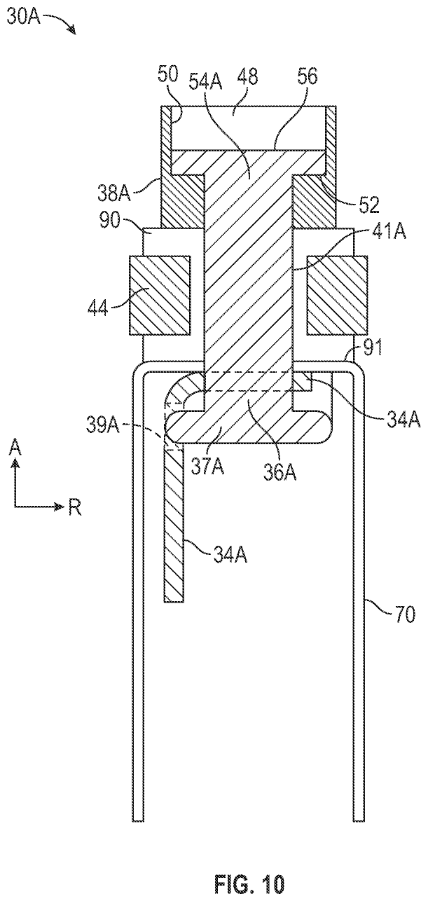

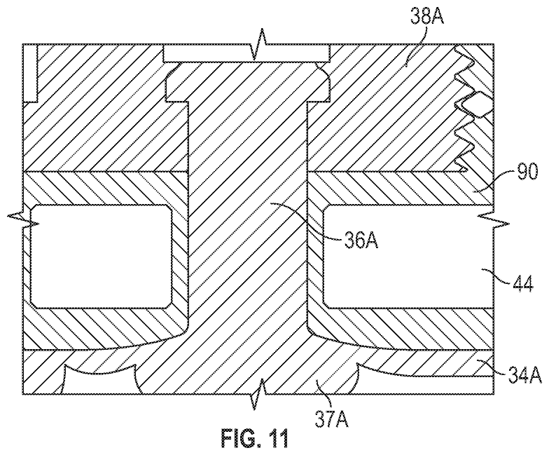

FIG. 12A shows another embodiment of the terminal assembly 30A. This embodiment is similar to the terminal assembly 30A of FIG. 11, with an additional rigid plate 160 disposed between. The plate 160 functions to reduce or eliminate the leak path resulting from deflection of the inner terminal body 34A. The plate 160 includes an opening to accommodate the feedthrough pin 36A. For example, the plate 160 includes a circular opening having a diameter selected so that the inner surfaces of the opening are flush with a side surface 41A of the feedthrough pin 36A, or within a selected tolerance. FIG. 12B shows a portion of the terminal assembly embodiment of FIG. 12A, showing the plate 160 after compression of the terminal assembly 30A. As shown, the rigid plate 160 compensates for the deflection of the inner terminal body and eliminates the leak path created by deflection of the body

One or more surfaces of the feedthrough pins 36 (including feedthrough pins 36A and 36B) may be smoothed, polished or otherwise treated to reduce surface roughness. Use of smoother surfaces have been surprisingly observed to reduce the leak rate of the terminal assembly. For example, a smooth, polished finish can be applied to side surface 41A, surfaces of the base portion 37A, top surfaces 44T of the cover 44, bottom surfaces 44B of the cover 44 and/or the inside diameter 44D of the cover 44 (See FIG. 9) to reduce the leak rate, for example to provide a He leak rate of 10⁻⁸ ccHe/s or less. Use of a surface finish of to 50 μm Ra, 0.2 to 40 μm Ra, 0.5 to 25 μm Ra, 0.7 to 20 μm Ra, or 1 to 8 μm Ra is mentioned. Surface finish can be determined according to ASTM A 480/A 480M, the content of which is incorporated herein by reference in its entirety.

A variety of manufacturing techniques may be used to make the terminal assemblies 30 and terminal systems as described herein. For example, suitable casting and/or injection molding and other molding techniques, additive manufacturing (e.g., 3-dimensional printing), bending techniques, and other manufacturing techniques might be utilized. Also, the various components of the apparatuses may be integrally formed, as may be desired, in particular when using casting or molding construction techniques.

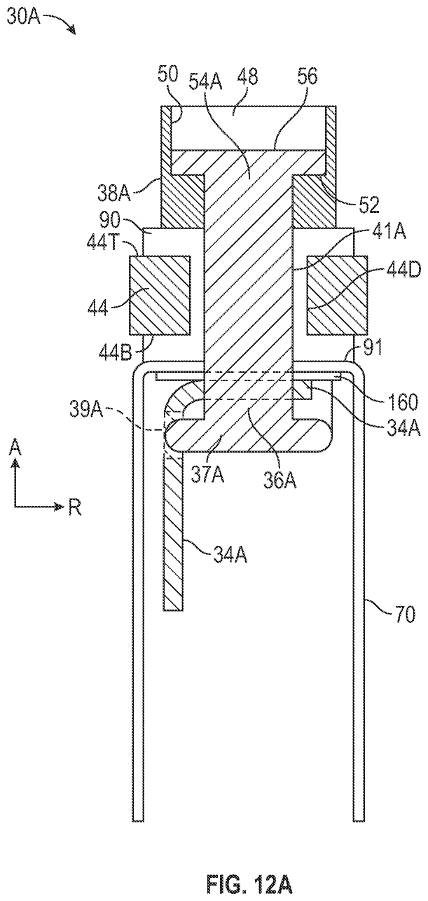

FIGS. 13-18 depict an embodiment of a method of manufacturing a terminal system and terminal assemblies 30. The method includes a number of stages, aspects of which are represented graphically by FIGS. 13-18. The stages may be performed in the order described, or one or more stages may be performed in a different order. In addition, the method may include fewer than all of the stages.

In a first stage, referring to FIG. 13, a cover 44 is provided, which includes through holes 45 that are positioned to align with holes in the terminal assemblies 30 and the position of feedthrough pins 36 when assembled. The cover 44 may made via any suitable process, such as casting, molding, or machining. In some embodiments, the cover 44 may be an integral part of a cell housing or casing, or may be later attached or connected thereto.

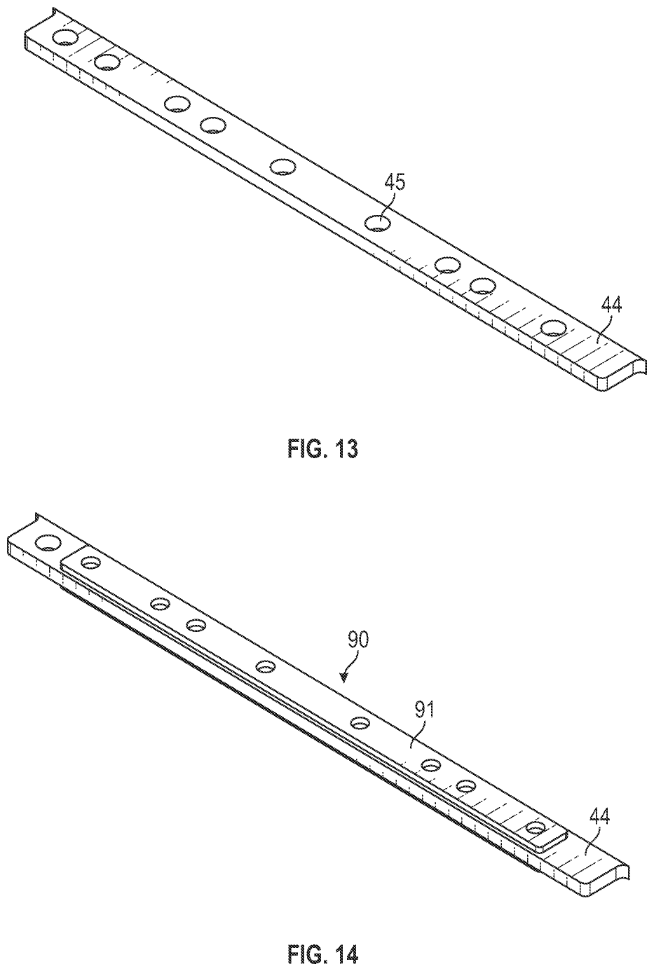

In a second stage, referring to FIG. 14, the cover 44 is overmolded with an insulating material or insulator 90, such as a polymer, to form a single molded body 91 that lines upper and lower surfaces of the cover 44 and also lines through holes 45. For example, the cover 44 is disposed within a blank, and the insulator 90 is injection molded to form the single molded body 91. To relieve stress, a cut or gap may be cut into the body 91. The insulator 90, can for example, serve the insulating purpose of insulators 60 and 70 and the bushings 80 of FIG. 3. Alternatively, the insulator 90 is formed from multiple parts. For example, as shown in FIG. 15, the insulator includes a first body 91A (e.g., that aligns with the negative terminal) and a second body 91B (e.g., that aligns with the positive terminal). The bodies 91A and 91B may be separated by an extent to allow for plastic deformation. For example, the bodies 91A and 91B are separated by 0.1 mm, 1 mm, or 10 mm, to 0.1 mm, 1 mm, 10 mm, or 40 mm, or any other suitable distance.

In a third stage, the inner terminal 32 is made having a terminal body 34 and feedthrough pins 36. The inner terminal 32 is either machined from a solid piece of material (e.g., copper or aluminum) or comprised of multiple parts. For example, the feedthrough pins 36 and terminal body 34 are machined from a solid piece of copper or aluminum. Alternatively, the feedthrough pins 36 are rivets of an appropriately stable material (e.g., copper or aluminum), which are inserted into holes in the terminal body 34 and may be subsequently ultrasonically welded or otherwise attached to improve the electrical connection beyond that achieved by the riveting forces.

For example, a positive inner terminal 32A includes a terminal body 34A and feedthrough pins 36A comprised of aluminum. A negative inner terminal 32B includes a terminal body 34B and feedthrough pins 36B comprised of copper.

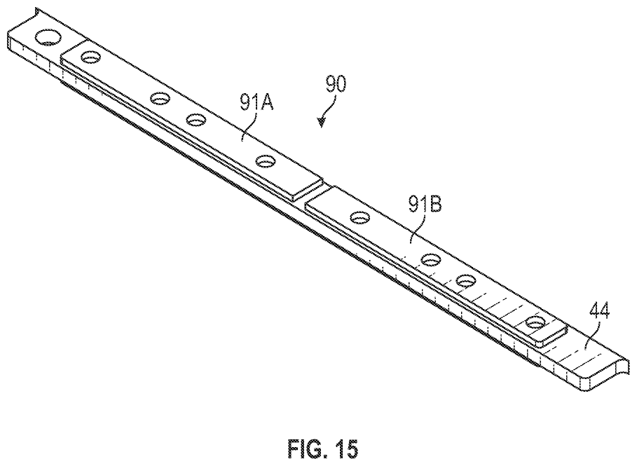

In the fourth stage, the inner terminal bodies 34A and 34B and the feedthrough pins 36A and 36B are disposed on a support block 94 that includes recesses 95 configured to hold the inner terminal bodies 34A and 34B in place (See FIG. 16A). In the fifth stage, the internal insulator 70 is initially provided as a flat plate made from an insulating material, and is disposed on the inner terminals 32A and 32B so that the feedthrough pins 36A and 36B extend through holes 71 in the flat plate (See FIG. 16B). In the sixth stage, the cover 44 with the overmolded insulator 90 is disposed on the internal insulator 70 so that the feedthrough pins 36A and 36B extend through the holes (See FIG. 16C). Optionally, a rigid plate 160 (shown in FIG. 12) may be included.

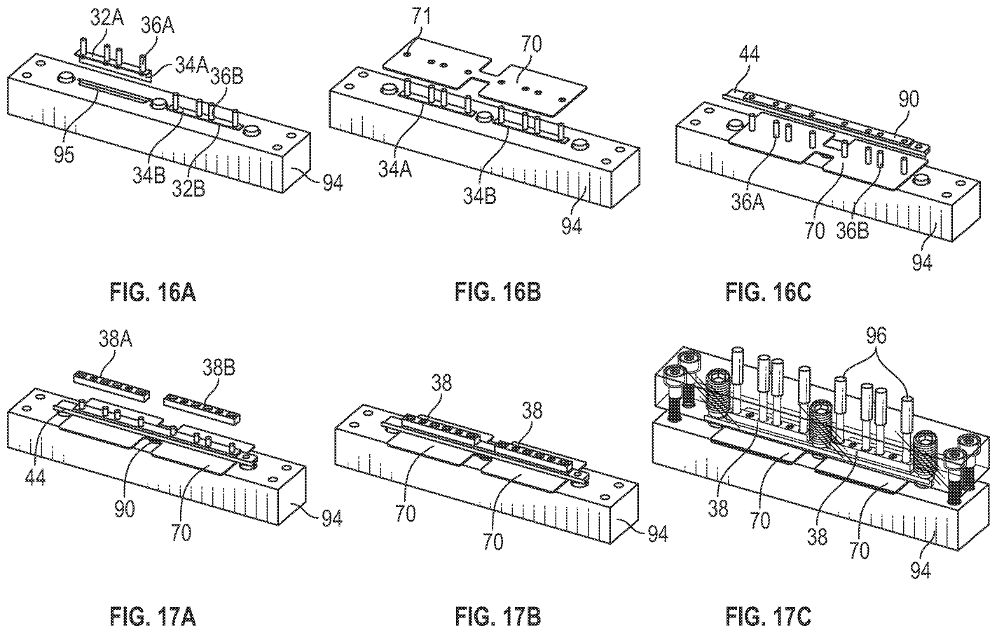

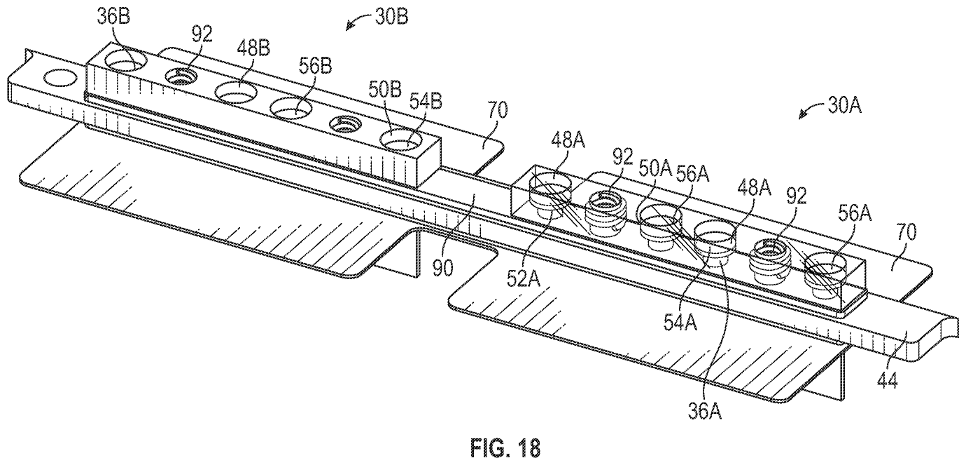

In the seventh stage, outer terminals 38A and 38B, which may be made from any suitable process (e.g., machining or casting), are positioned so that the feedthrough pins 36A and 36B extend through the feedthrough passages 46 therein (See FIGS. 17A and 17B). In this embodiment, each outer terminal 38A and 38B includes four feedthrough passages 46A and 46B, respectively, and two additional recesses having inner threading or threaded inserts 92 (See FIG. 18). The outer terminals 38A and 38B are, for example, both comprised of copper.

In the eighth stage, the head portions 54A of each feedthrough pin 36A, and the head portions 54B of each feedthrough pin 36B, are compressed, or otherwise deformed, to shape each head portion 54A and 54B to conform to a respective upper portion or recess (See FIG. 17C). The deformed head portions 54A and 54B may be subsequently laser welded, e.g., to eliminate any thermal expansion and contraction issues with dissimilar metals. For example, a force is applied to the head portions 54A and 54B via riveting mandrels 96 or another tool or technique (See FIG. 17C). The total compressive force may range from one times the yield strength (force sufficient to reach the yield point) to 100 times the yield strength, depending on the compression method. Typical rivet deformation methods include direct compression at constant or variable speed, traditional rivet hammering (impacting), or spin/orbital compression.

FIG. 18 shows the assembled terminal system and terminal assemblies 30A and after the feedthrough pins 36A and 36B have been deformed. As shown, each head portion 54A has been deformed to contact the seating surface 52A of each recess 48A, and to contact the side surface 50A of each recess 48A, thereby securing the terminal assembly 30A together and providing sealed electrical connections. This process provides a high surface area contact so as to reduce resistance of electrical current flowing through the terminal assemblies 30. Prior to installation of the terminal system 30 into a battery, the insulator 70 may be bent at a 90 degree angle, as shown. Similarly, each head portion 54B has been deformed to contact the seating surface 52B of each recess 48B, and to contact the side surface 50B of each recess 48B. Each head portion 54A and 54B defines a facing surface 56A and 56B, respectively.

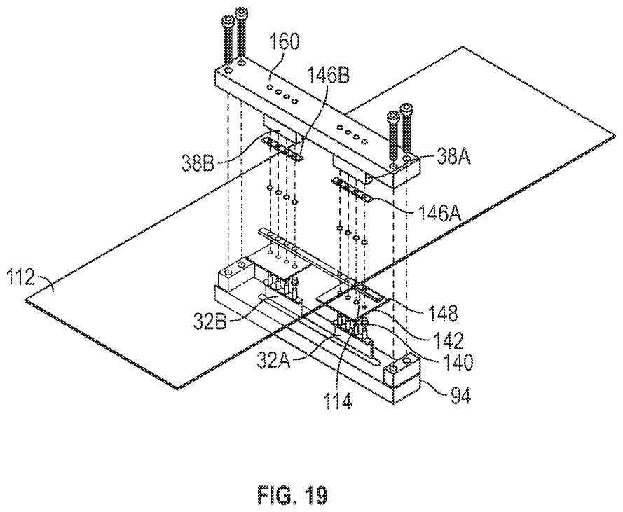

FIG. 19 depicts components of an embodiment of a terminal assembly 30. In this embodiment, the terminal assembly is part of a pouch-type cell, such as the cell 110 of FIGS. 5A-5D.

In a first stage, the inner terminal 32 is made having a terminal body 34 and feedthrough pins 36. The inner terminal 32 is either machined from a solid piece of material (e.g., copper or aluminum) or comprised of multiple parts. For example, the positive inner terminal 32A, including the terminal body 34A and aluminum feedthrough pins 36A, is positioned on the support block 94. The negative inner terminal 32B, including the terminal body 34B and copper feedthrough pins 36B, is also positioned in the support block 94

Bushings 140 are positioned on each of the feedthrough pins 36A and 36B, and an internal insulator 142 is disposed as a flat plate on the inner terminals 32A and 32B so that the feedthrough pins 36A and 36B extend through holes 144 in the flat plate.

Cover portions 146A and 146B are provided, which are separate outer insulators that are disposed at an exterior of the pouch 112, and separate the outer terminals 38A and 38B from the pouch 112. The covers 146A and 146B may be made from an insulating material.

A cover stiffening plate 148 is also provided, which provides thickness and spacing for the bushings 140 and helps to distribute compression. The cover stiffening plate 148 avoids push-through of the bushings 140 during assembly and compression by preventing the bushings 140 from pushing through the pouch 112 material. The cover stiffening plate 148 also prevents the pouch material from bending and misaligning the feedthrough assemblies.

The cover stiffening plate 148 is disposed over the internal insulator 142 so that the feedthrough pins 36A and 36B are aligned with holes in the cover stiffening plate 148. The pouch 112 is then positioned over the cover stiffening plate 148 so that holes in the cover stiffening plate 148 align with holes in the pouch (e.g., terminal apertures 128 as shown in FIG. 5D). Outer terminals 38A and 38B are positioned so that the feedthrough pins 36A and 36B align with the feedthrough passages 46A and 46B, respectively.

An upper block 160 is secured over the assembled components, and compression is applied so that the head portions 54A of each feedthrough pin 36A, and the head portions 54B of each feedthrough pin 36B, are compressed, or otherwise deformed, to shape each head portion 54A and 54B to conform to a respective upper portion or recess. If components are made from different materials, compression may be separately applied to compress each material. For example, copper components such as feedthrough pins 36B are compressed, and aluminum components such as the feedthrough pins 36A are separately compressed. Any suitable amount of compression may be applied, such as compression of at least 1.1 times (1.1×), 1.1× to 40×, 1.3× to 10×, or 1.5× to 3× the yield value of the material being compressed. For example, copper components may be compressed to a compression of 1.1×, 1.5× to 3×, 1.5× to 4× or 1.1× to 9×. Aluminum components may be compressed to a compression of 1.1×, 1.5× to 10×, or 1.1× to 30×.

For example, copper feedthrough pins 32B, each having a 0.09375 inch diameter, are compressed to 3,200 pounds (117,820 psi). For example, aluminum feedthrough pins 32A, each having a 0.09375 inch diameter, are compressed to 2,850 pounds (104,934 psi).

It is appreciated that the various components of embodiments described herein may be made from any of a variety of materials including, for example, metal, copper, aluminum, electroplating, stainless steel, nickel, titanium, plastic, plastic resin, nylon, composite material, glass, and/or ceramic, for example, or any other material as may be desired. The positive internal terminal can be constructed of aluminum. The negative internal terminal can be constructed of copper. The electrically insulating bushings can be constructed of any suitable polymeric material, for example ETFE or polysulfone.

As noted above, a cell, such as the cell 10, may include cooling features. For example, a cooling plate or other thermally conductive structure can be incorporated into an interior of the cell 10, in thermal communication with the terminal assembly 30, and/or in thermal communication with other components of the cell 10. This example is not intended to limit the cooling feature to any specific material or configuration.

FIG. 14 depicts aspects of a battery assembly 100, which illustrates an example of a cooling feature. The battery assembly 100 includes a plurality of cells 10, each having a respective terminal assembly 30. Adjacent terminal assemblies 30 may be electrically connected via intercell connectors 102. The cells 10, terminal assemblies 30 and intercell connectors 102 may be incorporated as a cell stack disposed in a housing (not shown) to form a battery module. The cells 10 and terminal assemblies 30 are configured to be in thermal communication with a cooling feature 104. The cooling feature 104 may be configured in any suitable manner such that heat is drawn from the cells 10. The cooling feature 104 may be a solid member such as a cooling plate made from a metallic material, or other type of material such as pyrolytic graphite. The ability to absorb heat may be enhanced by using water (or other fluid) cooling. For example, the cooling feature can be a water-cooled plate, or a body having fluid passages therein (e.g., a pipe or plurality of pipes). Other components such as a thermal interface 106 (e.g., an aluminum nitride or gap pad interface) may be included to facilitate heat transfer and/or electrical isolation from the battery assembly 100 to the cooling feature 104. In an embodiment (e.g., if the thermal interface 106 is a hard, non-compliant material), the thermal interface 106 can be bonded to the battery assembly 100 by applying a thermally conductive adhesive, such as epoxy or thermal grease, between the thermal interface 106 and the intercell connectors 102, and also applying a thermally conductive adhesive between the thermal interface 106 and the battery assembly 100. If the thermal interface is compliant, in an embodiment, use of an additional material between the battery assembly 100 and the thermal interface 106, or between the intercell connectors 102 and the thermal interface can be omitted. The various apparatuses and components of the apparatuses, as described herein, may be provided in various sizes, shapes, and/or dimensions, as desired.

It will be appreciated that features, elements and/or characteristics described with respect to one embodiment of the disclosure may be variously used with other embodiments of the disclosure as may be desired.

It will be appreciated that the effects of the present disclosure are not limited to the above-mentioned effects, and other effects, which are not mentioned herein, will be apparent to those in the art from the disclosure and accompanying claims.

Although the preferred embodiments of the present disclosure have been disclosed for illustrative purposes, those skilled in the art will appreciate that various modifications, additions and substitutions are possible, without departing from the scope and spirit of the disclosure and accompanying claims.

Spatially relative terms, such as “lower”, “upper”, “top”, “bottom”, “left”, “right” and the like, may be used herein for ease of description to describe the relationship of one element or feature to another element(s) or feature(s) as illustrated in the drawing figures. It will be understood that spatially relative terms are intended to encompass different orientations of structures in use or operation, in addition to the orientation depicted in the drawing figures. For example, if a device in the drawing figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein should be interpreted accordingly. The endpoints of ranges may be independently combined.

The terminology used herein is for the purpose of describing particular embodiments only and is not intended to be limiting of the disclosure. As used herein, the singular forms “a”, “an” and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to diagrams and/or cross-section illustrations, for example, that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of components illustrated herein but are to include deviations in shapes that result, for example, from manufacturing.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment.

Further, as otherwise noted herein, when a particular feature, structure, or characteristic is described in connection with any embodiment, it is submitted that it is within the purview of one skilled in the art to effect and/or use such feature, structure, or characteristic in connection with other ones of the embodiments.

Embodiments are also intended to include or otherwise cover methods of using and methods of manufacturing any or all of the elements disclosed above.

While the subject matter has been described in detail with reference to exemplary embodiments thereof, it will be apparent to one skilled in the art that various changes can be made, and equivalents employed, without departing from the scope of the disclosure.

All related art references and art references discussed herein are hereby incorporated by reference in their entirety. All documents referenced herein are hereby incorporated by reference in their entirety.

In conclusion, it will be understood by those persons skilled in the art that the present disclosure is susceptible to broad utility and application. Many embodiments and adaptations of the present disclosure other than those herein described, as well as many variations, modifications and equivalent arrangements, will be apparent from or reasonably suggested by the present disclosure and foregoing description thereof, without departing from the substance or scope of the disclosure.

Accordingly, while the present disclosure has been described here in detail in relation to its exemplary embodiments, it is to be understood that this disclosure is only illustrative and exemplary of the present disclosure and is made to provide an enabling disclosure of the disclosure. Accordingly, the foregoing disclosure is not intended to be construed or to limit the present disclosure or otherwise to exclude any other such embodiments, adaptations, variations, modifications and equivalent arrangements.

What is claimed is:

1. A cell terminal assembly comprising:
an outer terminal configured to be disposed at an external location of a cell, the outer terminal including a feedthrough passage, the feedthrough passage including a recess having a seating surface; and
an inner terminal including an electrically conductive body configured to be disposed within a housing of the cell, the inner terminal including a feedthrough member electrically connecting the conductive body to the outer terminal, the feedthrough member including a head portion having a shape that conforms to a shape of the recess and the seating portion and secures the feedthrough member thereto.

2. The cell terminal assembly of claim 1, wherein the head is shaped via deformation.

3. The cell terminal assembly of claim 2, wherein the feedthrough member includes a rivet.

4. The cell terminal assembly of claim 1, wherein the feedthrough passage includes a lower portion having a first diameter, the recess forming an upper portion of the feedthrough passage and having a second diameter greater than the first diameter.

5. The cell terminal assembly of claim 4, wherein the recess includes a counterbore.

6. The cell terminal assembly of claim 4, wherein the seating surface faces an axial direction that is at least partially parallel to a longitudinal axis of the feedthrough member, and the recess includes a side surface facing a radial direction that is at least partially orthogonal to the longitudinal axis, the head portion having a sealing engagement to both the seating surface and the side surface.

7. The cell terminal assembly of claim 1, wherein the feedthrough member is integral with the conductive body.

8. The cell terminal assembly of claim 1, wherein the feedthrough member is a separate component that is attached to the conductive body.

9. A cell terminal assembly comprising:
an outer terminal configured to be disposed at an external location of a cell, the outer terminal including a feedthrough passage, the feedthrough passage including a recess having a seating surface; and
an inner terminal including an electrically conductive body configured to be disposed within a housing of the cell, the inner terminal including a feedthrough member configured to electrically connect the conductive body to the outer terminal, the feedthrough member including a head portion configured to be shaped to conform to a shape of the seating portion and secure the feedthrough member thereto.

10. The cell terminal assembly of claim 9, wherein the head is configured to be shaped via deformation.

11. The cell terminal assembly of claim 10, wherein the feedthrough member includes a rivet.

12. The cell terminal assembly of claim 9, wherein the feedthrough passage includes a lower portion having a first diameter, the recess forming an upper portion of the feedthrough passage and having a second diameter greater than the first diameter.

13. The cell terminal assembly of claim 12, wherein the recess includes a counterbore.

14. The cell terminal assembly of claim 12, wherein the seating surface faces an axial direction that is at least partially parallel to a longitudinal axis of the feedthrough member, and the recess includes a side surface facing a radial direction that is at least partially orthogonal to the longitudinal axis, the head portion configured to be shaped having a sealing engagement with both the seating surface and the side surface.

15. The cell terminal assembly of claim 9, wherein the feedthrough member is integral with the conductive body.

16. The cell terminal assembly of claim 9, wherein the feedthrough member is a separate component that is attached to the conductive body.

17. A method of manufacturing a cell terminal assembly, the method comprising:
providing an inner terminal including an electrically conductive body configured to be disposed within a housing of the cell, the inner terminal including a feedthrough member;
electrically connecting the inner terminal to an outer terminal configured to be disposed at an external location of a cell, the outer terminal including a feedthrough passage that includes a recess having a seating surface, wherein the connecting includes:
inserting the feedthrough member into the feedthrough passage, and deforming a head portion of the feedthrough member to conform the head portion to a shape of the recess, the deformed head portion providing an electrical connection between the inner terminal and the outer terminal and providing a fluid tight seal between the head portion and the seating surface.

18. The method of claim 1, wherein the feedthrough passage includes a lower portion having a first diameter, the recess forming an upper portion of the feedthrough passage and having a second diameter greater than the first diameter.

19. The method of claim 18, wherein the seating surface faces an axial direction that is at least partially parallel to a longitudinal axis of the feedthrough member, and the recess includes a side surface facing a radial direction that is at least partially orthogonal to the longitudinal axis, the head portion deformed to form a sealing engagement with both the seating surface and the side surface.

20. The method of claim 17, wherein deforming the head portion includes compressing the head portion to cause the head portion to contact the seating surface and the side surface.
